(19) United States
(12) Patent Application Publication
(10) Pub. No.: US 2009/0052540 A1
(43) Pub. Date: Feb. 26, 2009

(54) Quality based video encoding

(75) Inventors: Ron Gutman, Zichron-Yaakov (IL); Doron Segev, Tel-Aviv (IL); Noam Eshkoli, Tel-Mond (IL); Lorenzo Bombelli, Del Mar, CA (US); Yves Bouoreau, Cumming, GA (US)

Correspondence Address: ROBERT G. LEV, 4766 MICHIGAN BLVD., YOUNGSTOWN, OH, 44505, US

(73) Assignee: Imagine Communication Ltd., Netanya (IL)

(21) Appl. No.: 12/152,814

(22) Filed: May 16, 2008

Related U.S. Application Data
(60) Provisional application No. 60/957,639, filed on Aug. 23, 2007.

(51) Int. Cl. H04N 7/26; H04N 9/64

(52) U.S. Cl. 375/240.24; 348/720; 375/E07.189

(57) ABSTRACT

A method of preprocessing a video stream including receiving a video stream formed of a sequence of blocks and setting one or more quality level constraints for the video stream. The method further includes selecting for each of at least a plurality of the blocks of the video stream, one or more sets of compression parameters for compressing the block, such that the block compressed according to the set of parameters meets a respective quality level constraint set for the video stream and generating for each of the sets of compression parameters a corresponding data unit representing the block compressed by the set of compression parameters.

### PRIORITY INFORMATION

The present invention claims priority, under 35 USC 119(e), to U.S. Provisional Application No. 60/957,639 filed on Aug. 23, 2007.

### FIELD OF THE INVENTION

The present invention relates to communication systems and in particular to systems for delivery of video signals.

### BACKGROUND OF THE INVENTION

Delivering video content requires large amounts of bandwidth. Even when optical cables are provided with capacity for many tens of uncompressed channels, it is desirable to deliver even larger numbers of channels using data compression. Therefore, video compression methods, such as MPEG 2, H.264, Windows Media 9 and SMTPE VC-9, are used to compress the video signals. With the advent of video on demand (VoD), the bandwidth needs are even greater.

In the MPEG-2 compression standard, a video stream is compressed into a stream of media units. Each media unit relates to a physical aspect of the compressed video stream, such as a group of pictures (GOP), frame, slice or macro-block. The media units may have different data sizes in bits according to the specific momentary content of the video stream (e.g., frames with many details or few details, similar adjacent frames or largely varying sequences of frames).

In many cases it is desirable to have the video stream compressed into a constant quality level over the entire video stream. It is noted, however, that for a given quality level, some video frames, such as those having a large amount of detail, can be compressed only to a small extent, while other video frames (e.g., frames merely showing a blue sky) can be compressed to a larger extent. Therefore, many video compression methods provide variable bit-rate (VBR) video streams, in which different frames are compressed by different amounts.

While VBR is a good solution for DVD storage of video streams, it may be problematic for transmission on a communication channel, as the utilization level of the channel will be relatively low.

U.S. Pat. No. 7,082,167 to Alexandre et al., issued Jul. 25, 2006, the disclosure of which is incorporated herein by reference, describes a method in which a coder receives information concerning the complexity of the compressed video and compresses the video accordingly, to obtain video at a predetermined quality. The video stream is transmitted with other data, which utilizes the channel capacity not required by the video stream.

In some cases, however, a compromise is sought between keeping a constant quality level over the video stream and channel utilization.

U.S. patent publication 2005/0002453 to Chang et al., published Jan. 6, 2005, the disclosure of which is incorporated herein by reference, describes a compressor that generates an output stream with a maximal quality for an allocated bandwidth.

U.S. patent publication 2006/0165168 to Boyce et al., published Jul. 27, 2006, the disclosure of which is incorporated herein by reference, describes an encoder which encodes a video stream in accordance with a plurality of different encoding parameters in a preliminary stage and accordingly selects a best quality compression meeting the network bandwidth constraint. The described encoder is directed to achieving as little variation in quality throughout the video stream as possible.

A similar setup is described in U.S. patent publication 2003/0012275 to Boice et al., published Jan. 16, 2003, the disclosure of which is incorporated herein by reference.

In order to make better use of the bandwidth of a communication channel, statistical multiplexing may be used to combine a plurality of video streams onto a single communication channel. Statistical multiplexing increases the bandwidth provided to each video stream, but there are still times at which the video streams require further compression in order to allow them all to fit on the channel. Fairness may require that at such times all the video streams have a substantially equal quality.

U.S. Pat. No. 6,192,083 to Linzer et al., issued Feb. 20, 2001, the disclosure of which is incorporated herein by reference, describes a system in which prestored a-priori statistics concerning image complexity of multiplexed streams are used by a statistical multiplexer to better maintain consistent video quality across multiple encoded bit streams.

Compression is generally a complex process that requires large processing resources, and where possible, compression in advance is desirable. In addition, compression is often performed in a central location rather than in a plurality of remote locations.

U.S. Pat. No. 6,674,796 to Haskell et al., the disclosure of which is incorporated herein by reference, describes a preliminary encoder which compresses video streams and during the compression generates encoding results, such as optimal motion vectors and inter/intra decisions. Encoders of a statistical multiplexer use the generated encoding results in the encoding of the video streams.

U.S. Pat. No. 6,054,943 to Lawrence, the disclosure of which is incorporated herein by reference, describes a video compression method in which two preprocessing modules are used to calculate lossless and lossy compression representations, respectively, for a video content. The compression varies seamlessly between lossy and lossless modes according to the attributes of the channel.

U.S. Pat. No. 5,847,760 to Elmaliach et al., the disclosure of which is incorporated herein by reference, describes a variable bandwidth transmission system for broadcasting compressed video signals in which an encoder encodes each video frame (including a plurality of groups of pictures) at a maximal bit rate, half the maximal bit rate and at a quarter of the maximal bit rate. A transmitter controller selects which encoding is used according to available bandwidth.

U.S. patent publication 2006/0195881 to Segev et al., the disclosure of which is incorporated herein by reference, describes a distributed statistical multiplexing of video data, in which a multiplexer uses interchangeable blocks in adjusting the size of a video stream to network conditions.

### SUMMARY OF THE INVENTION

An aspect of some embodiments of the present invention relates to a preparation unit configured to encode a video stream, or portions thereof, in accordance with a plurality of quality levels, and to provide for at least some blocks of the video stream, a plurality of data units representing the block at corresponding different quality levels. Optionally, each of the data units is accompanied with an indication of its quality level, or the quality levels can otherwise be determined, for example from the order of providing the data units. In some embodiments of the invention, the plurality of data units comprise complete video data representations of the block at the quality level of the data unit. Alternatively, one or more of the data units comprises compression hints for preparing the block at the corresponding quality level.

A channel loading unit optionally selects for each block one of the quality levels and accordingly transmits a corresponding block representation. While providing data units based on quality rather than size may achieve a slightly lower channel utilization rate, the use of quality levels allows accurate monitoring of the quality of the video signals supplied. Furthermore, when the channel loading unit comprises a statistical multiplexer, using quality level indications allows simple allocation of the channel bandwidth to a plurality of video streams in a fair manner.

An aspect of some embodiments of the present invention relates to a method of statistical multiplexing in which a channel loader selects sizes of a plurality of video streams loaded onto a delivery channel, according to quality, in order to achieve a desired quality distribution of the delivery channel. In some embodiments of the invention, the sizes of the video streams are selected in a manner which achieves a substantially equal quality for all the video streams, for example with qualities differing by less than 3% or even less than 1%. Alternatively, one or more of the video channels are allocated predetermined sizes according to their quality of service agreements and the remaining bandwidth of the delivery channel is divided between other channels in a manner which provides substantially even quality for all the channels or for all the other channels. Further alternatively or additionally, the sizes of the video streams are allocated in a manner which provides a predetermined quality difference between the video streams. For example, a first group of channels may be promised a quality level X percentage points greater than the quality of a second group of channels.

The video streams loaded onto the delivery channel may be loaded in the form of constant bit rate (CBR) streams, variable bit rate (VBR) streams or any other form. For example, the video streams may be loaded onto the delivery channel as pseudo VBR streams which have a constant bit rate during predetermined periods, but the constant bit rate may change between periods. For example, for every period of a second or two seconds, the channel loader may select a bit rate for each of the channels to be used during that period. In some embodiments of the invention, different video streams loaded onto the delivery channel have different formats. For example, some of the channels may be provided with constant bit rates, some with variable bit rates and some with pseudo variable bit rates.

An aspect of some embodiments of the present invention relates to a video stream delivery system, which is adapted to provide for video streams it supplies, a report on the quality levels of the blocks of the video streams supplied. Optionally, the report for a specific video stream indicates for each quality level used by one or more blocks of the video stream, the percentage of blocks of the video stream at that quality level and/or the average quality level of the video stream. Alternatively or additionally, the report indicates the percentage of blocks having a quality level below a given quality level. In some embodiments of the invention, when the percentage of blocks having a quality level below the given quality level exceeds a predetermined threshold, a warning message is generated. In one exemplary embodiment, two quality levels are provided and a warning message is generated if the lower quality level is used for more than 1% of the time.

An aspect of some embodiments of the invention relates to a preparation unit configured to encode a video stream into blocks and to provide for at least some blocks of the video stream, a plurality of data units representing the block and/or instructions concerning how to generate the plurality of data units. In addition, the preparation unit provides instructions for a plurality of data unit arrangements forming the video stream in respective specific bit rates and/or quality levels. Based on the instructions, channel loading units may load the video stream onto a channel of a specific width and/or at a required quality level. This allows the channel loading units to be simpler and to require less processing resources.

An aspect of some embodiments of the invention relates to delivering constant bit rate video channels to channel loaders padded with null bytes into a larger constant bit rate stream, such that the padded delivered video channel always has the same size. Transmitting a same size channel at all times makes the switching at the channel loader simpler (in case the number of channels change), as the size of the received channel is constant.

An aspect of some embodiments of the present invention relates to a video preparation unit adapted to select one or more compression parameters to be applied to a video stream, responsive to a source, time or content of the video stream. For example, the one or more compression parameters may be selected responsive to which TV channel is the source of the video stream, the classification of the stream in an electronic program guide (EPG), the time and/or date and/or any classification of the content of the stream. These embodiments may be particularly useful when the preparation unit handles a real time video stream and has a limited time in which to perform the compression. It is noted, however, that the use of these embodiments may be advantageous also in non-real-time scenarios, in order to achieve a more efficient compression. In some embodiments of the invention, the section of the one or more compression parameters is based on information not derived from the video stream itself.

The selected one or more parameters optionally relate to the compression result. In some embodiments of the invention, the selected one or more parameters include one or more quality levels to which the stream is to be compressed and/or one or more sizes to which the stream is to be compressed.

An aspect of some embodiments of the present invention relates to a video server which determines whether to comply to a request for a video stream at least partially based on a determination of whether the video stream can be provided at a given quality level.

In some embodiments of the invention, the request is accompanied by an indication of a required minimal quality level. Alternatively or additionally, the server determines a minimal quality level for users, for example responsive to a desired reputation of a service provider managing the video server. Optionally, a user may indicate willingness to receive the video stream at a lower quality, in which case the decision not to supply the video stream due to its quality is overridden by the user.

Optionally, the video server determines for the specific video stream requested what bandwidth is required for the minimal quality level and this required bandwidth is compared to the bandwidth available for delivery to the client requesting the video stream.

In some embodiments of the invention, each video stream is associated with a simple size measure indicative of the bandwidth requirements of the stream. For non-real time video streams, the simple size measure is optionally determined in advance, based on the contents of the entire video stream. For real time streams, on the other hand, the simple size measure is optionally determined on the fly, based on the portion of the video stream already viewed. In some embodiments of the invention, the simple size measure comprises a single scalar. An aspect of some embodiments of the present invention relates to a video preparation unit adapted to compress video blocks using a plurality of different sets of parameter values to form a first number of compressed data units and to select from the first number of data units a sub-group of a plurality of compressed data units including fewer than the first number of data units, for transmission. Optionally, the selection is performed according to quality level constraints. In some embodiments of the invention, the selection is directed to selecting compressed data units with closest values to predetermined value levels, for example size or quality levels. The predetermined value levels are optionally substantially separated from each other, so that the transmitted compressed data units have diverse parameter values.

An aspect of some embodiments of the present invention relates to a method of providing video to clients. The method includes transmitting a video stream from a first location to a channel loader and transmitting compression hints for at least some blocks of the video stream from a second location different from the first location, to the channel loader. The channel loader modifies the video stream using the compression hints from the second location and forwards the modified stream to a client. Optionally, the first and second locations host servers maintained by different entities. Alternatively or additionally, the first and second locations are in separate rooms or even in different buildings. In some embodiments of the invention, the first and second locations are separated by at least 100 meters, by at least a kilometer, or even by at least 10 kilometers.

An aspect of some embodiments of the invention relates to a video server system including a plurality of preparation units, which provide the same video streams for redundancy, but provide the video streams in different formats. Optionally, the preparation units provide the video streams at different compression bit rates and/or qualities, allowing a channel loader or other unit receiving the provided video streams more flexibility in loading the channel, when the redundancy is not required. The preparation units are optionally positioned in a same location, possibly in a same room or even a same casing.

In some embodiments of the invention, the preparation units provide data units representing blocks of the video stream, at different quality levels. Optionally, the provided data units of the different preparation units have close quality levels, for example with quality levels differing by no more than 2%.

There is therefore provided in accordance with an exemplary embodiment of the invention, a method of preprocessing a video stream, comprising receiving a video stream formed of a sequence of blocks; setting one or more quality level constraints for the video stream; selecting for each of at least a plurality of the blocks of the video stream, one or more sets of compression parameters for compressing the block, such that the block compressed according to the set of parameters meets a respective quality level constraint set for the video stream; and generating for each of the sets of compression parameters a corresponding data unit representing the block compressed by the set of compression parameters.

Optionally, setting one or more quality level constraints comprises setting a required minimal quality level or average quality level. Optionally, setting one or more quality level constraints comprises setting constraints which do not change over the entire video stream.

Optionally, setting one or more quality level constraints comprises setting constraints which vary over the video stream. Optionally, selecting one or more sets of compression parameters comprises compressing the block according to a plurality of different sets of parameters and selecting a sub set of compression parameters that meet the quality level constraints. Optionally, the quality constraints comprise average quality values and selecting the sub set of compression parameters comprises selecting the compression parameters resulting in compressed blocks having a quality level closest to respective average quality values. Optionally, compressing the block according to a plurality of different sets of parameters comprises compressing according to at least some parameters selected responsive to external information on the general content of the video stream. Optionally, the external information is retrieved from an external program guide describing the stream. Optionally, selecting one or more sets of compression parameters comprises iteratively adjusting the parameters based on test compressions. Optionally, generating the corresponding data unit comprises compressing the block according to the set of compression parameters, such that the data unit is a compressed version of the block meeting the quality level constraint.

Optionally, generating the corresponding data unit comprises generating a data unit including the set of compression parameters, but not the video block.

Optionally, the block comprises a group of pictures (GOP). Optionally, the method includes calculating one or more values indicative of a bit rate of the stream corresponding to each of the one or more quality level constraints, responsive to the selection of the compression parameters. Optionally, setting the one or more quality level constraints comprises setting responsive to a rating of the video stream. Optionally, setting the one or more quality level constraints comprises setting responsive to a request of a provider of the video stream. Optionally, the method includes providing quality indications with at least some of the data units. Optionally, for at least a plurality of the blocks, a plurality of data units of different quality levels are generated. Optionally, a plurality of data units of different quality levels are provided for at least 5% of the blocks of the video stream. Optionally, a plurality of data units of different quality levels are provided for at least 50% of the blocks of the video stream. Optionally, providing one or more data units for each of the blocks of the video stream comprises providing the video stream from a first location and additional units from a second location.

Optionally, the method includes selecting for each time interval corresponding to a block of the video stream, a single data unit representing the video stream in the time interval. Optionally, selecting for each time interval a single block is performed at least an hour after selecting the compression parameters. Optionally, the method includes taking note of the quality levels of the selected blocks. Optionally, selecting for each time interval a single data unit is performed at a location distanced from the location in which the compression parameters are selected.

Optionally, the method includes generating for at least one set of compression parameters for a specific current block of the video stream a plurality of data units representing the current block at a same quality level but differing in a quality level of a previous block on which the encoding of the current block depends. Optionally, the method includes verifying that the set of compression parameters achieve the quality level constraint by compressing the blocks using the set of compression parameters and comparing the compressed block to the original block to determine the quality level.

There is further provided in accordance with an exemplary embodiment of the invention, a video preparation unit, comprising an input interface for receiving video streams formed of sequences of blocks; an output interface for providing preprocessed data units for the video stream; and one or more encoders configured to select for at least 5% of the blocks of video streams received through the input interface, compression parameters suitable for compressing the block into a compressed block meeting a quality level constraint associated with the video stream, and to forward data units including the compression parameters or compressed versions of the blocks generated according to the compression parameters, through the output interface.

Optionally, the one or more encoders are configured to forward the data units with the video stream. Optionally, the one or more encoders are configured to forward the data units without the video stream. Optionally, the one or more encoders are configured to forward the compression parameters or the data units along with quality indications.

Optionally, the one or more encoders are adapted to calculate one or more values indicative of a bit rate of the stream corresponding to the quality level constraint associated with the video stream.

There is further provided in accordance with an exemplary embodiment of the invention, a method of channel loading one or more video streams, comprising receiving one or more video streams, including sequences of data units representing blocks of the video stream, wherein at least 1% of the blocks of the video stream are represented by a plurality of data units having different quality levels; determining quality levels of the data units; selecting for each of the one or more video streams, at each time point, a single data unit to represent the video stream at the time point, responsive to the determined quality levels; and loading representations of the one or more video streams onto a communication channel, responsive to the selected data units.

Optionally, loading representations of the one or more video streams onto a communication channel comprises loading each of the one or more streams as a constant bit rate stream on its own. Optionally, loading representations of the one or more video streams onto a communication channel comprises loading the one or more streams together as a constant bit rate stream. Optionally, each of the data units comprises a compressed version of the block or a respective set of compression parameters to be used in compressing the block.

Optionally, receiving one or more video streams comprises receiving a plurality of video streams by a statistical multiplexer. Optionally, selecting for each video stream a single data unit comprises selecting in a manner which evenly distributes reduction in quality between the video streams. Optionally, selecting for each video stream a single data unit comprises selecting in a manner which causes the video streams to have substantially even quality levels. Optionally, selecting for each video stream a single data unit comprises selecting in a manner which maximizes the overall quality level of all the video streams.

Optionally, determining the quality levels of the data units comprises receiving level indications with the data units. Optionally, determining the quality levels of the data units comprises determining the quality levels by a same processor performing the selecting.

There is further provided in accordance with an exemplary embodiment of the invention, a channel loader, comprising an input interface for receiving video streams formed of sequences of blocks; an output interface for loading video streams onto a communication channel; and a processor configured to receive through the input interface sequences of data units of one or more video streams, to determine quality levels of the data units, to select for each of the one or more video streams, at each time point, a single data unit to represent the video stream at the time point, responsive to the determined quality levels and to load representations of the one or more video streams onto a communication channel through the output interface, responsive to the selected data units.

There is further provided in accordance with an exemplary embodiment of the invention, a method of channel loading, comprising determining one or more video streams to be provided on a delivery channel; receiving an indication of a bit rate of the delivery channel; and selecting for each of the one or more video streams a target quality level to which the video stream is to be compressed, responsive to the bit rate of the delivery channel.

Optionally, selecting the target quality comprises selecting responsive to the compression sizes achieved for previous blocks of the video stream. Optionally, selecting the target quality comprises selecting responsive to the compression sizes achieved for similar blocks of the video stream or of similar video streams. Optionally, the similar video streams have a similar entry in an electronic program guide as the current video. Optionally, the method includes compressing the one or more video streams to the selected quality levels. Optionally, the method includes repeating the compression of one or more blocks of a stream if the bit rate of the compressed block is substantially different from the bit rate of the delivery channel.

Optionally, the one or more video streams comprise a plurality of video streams. Optionally, the method includes receiving rules defining the relative quality levels of the streams to be provided on the delivery channel. Optionally, providing the rules defining the quality levels of the streams comprises providing a rule requiring that the streams have substantially equal quality. Optionally, providing the rules defining the quality levels of the streams comprises providing a rule defining a plurality of groups of streams, the streams of each group having substantially the same quality level, which is different from the quality levels of the other groups. Optionally, providing the rules defining the quality levels of the streams comprises providing a rule requiring a predetermined difference between the quality levels of at least two streams.

Optionally, encoding the streams comprises encoding each stream into a constant bit rate stream. Optionally, the encoding is performed by a channel loader which receives indications of a plurality of quality levels and respective sizes for at least two of the video streams, along with the video streams. Optionally, the encoding is performed by a channel loader which receives indications of a plurality of quality levels and respective sizes for at least two of the video streams, from a separate entity. Optionally, determining video streams to be provided on the channel comprises determining whether to accept an additional request for a video stream, responsive to an expected quality level at which the video stream will be supplied. Optionally, compressing the one or more video streams comprises encoding in a manner which maximizes the quality levels of the one or more streams, while the streams still fit on the delivery channel.

There is further provided in accordance with an exemplary embodiment of the invention, a method of video stream delivery, comprising: receiving a video stream, formed of a sequence of a plurality of blocks, for delivery to a client; transmitting for each block of the video stream, a compressed video block to the client; determining for each transmitted compressed video block a quality level of the block; and providing a report on the quality levels of the compressed video blocks provided to the client.

Optionally, determining, for each block, a quality level of the block comprises determining by a client receiving the blocks, such as a set-top box. Optionally, determining, for each block, a quality level of the block comprises determining from quality indications received with the transmitted blocks. Optionally, receiving the video stream comprises receiving for at least some of the blocks of the video stream a plurality of data units representing the block at respective known quality levels. Optionally, the method includes adjusting production of the plurality of data units responsive to the provided report. Optionally, the method includes performing routing decisions for video streams in a network, responsive to the provided report.

There is further provided in accordance with an exemplary embodiment of the invention, a video preparation unit, comprising a communication interface; and a processor configured to determine for video streams formed of sequences of blocks, at least some of the blocks being represented by a plurality of data units of different sizes, a plurality of different data unit arrangements forming video streams of different sizes, and to transmit descriptions of the plurality of arrangements through the communication interface to one or more channel loaders. Optionally. the processor is configured to determine compression parameters of the plurality of data units of different sizes. Optionally. the plurality of different arrangements define video streams of constant bit rate. Optionally, the processor is configured to define quality levels and accordingly create the arrangements. Optionally, the processor is configured to define stream sizes and accordingly create the arrangements.

There is further provided in accordance with an exemplary embodiment of the invention, a method of preprocessing a video stream, comprising receiving a video stream, providing a plurality of data units to represent the stream, the plurality of data units including for at least 1% of the blocks of the streams, a plurality of respective data units corresponding to different compressed block sizes; and generating a plurality of different data unit arrangements forming video streams of different sizes.

There is further provided in accordance with an exemplary embodiment of the invention, a channel loading unit, comprising: an input interface for receiving a video stream and additional information on the stream; an output interface for loading a version of the video stream at a desired size on a communication link leading to a client; and a processor configured to receive through the input interface, for at least some blocks of a video stream, data units or instructions to generate the data units, representing the blocks at a plurality of different sizes, to receive a plurality of listings of arrangements of data units for constructing the video stream at different sizes, to construct a video stream using one of the arrangement listings and to forward the constructed video stream through the output interface.

There is further provided in accordance with an exemplary embodiment of the invention, a method of delivering a video stream, comprising: providing a video stream; padding the video stream with null bytes into a constant bit rate stream, having a size larger than the minimal constant bit rate stream encompassing the provided video stream; and forwarding the padded video stream to a channel loader.

Optionally, providing the video stream comprises providing a constant bit rate video stream of a first size and padding the video stream comprises padding the video stream with null bytes to a second size.

There is further provided in accordance with an exemplary embodiment of the invention, a method of video compression, comprising: receiving, by a compression unit, a video stream along with external data related to the video stream; selecting one or more compression parameters, responsive to the external data related to the video stream; and compressing the video stream using the selected one or more compression parameters.

Optionally, the external data comprises information on a source of the video stream.

Optionally, the received video stream comprises a real time broadcast video stream and wherein the external data comprises information on a time or content of the broadcast. Optionally, the external data comprises a classification of the stream in an electronic program guide (EPG). Optionally, selecting the one or more compression parameters comprises selecting a quality level target of the compression. Optionally, selecting the one or more compression parameters comprises selecting a size target of the compression.

There is further provided in accordance with an exemplary embodiment of the invention, a method of supplying a video stream to a client, comprising receiving a request for a video stream from a client, by a video network unit; selecting a minimal quality level required for the requested video stream; determining whether an available route can accommodate delivery of the requested video stream to the client at the minimal quality level; and supplying the video stream to the client on an available route which can accommodate the requested video stream at the minimal quality level and not providing the video stream to the client if such route does not exist.

Optionally, determining whether the available route can accommodate delivery of the requested video stream to the client at the minimal quality level comprises determining an average bit rate of the video stream at the minimal quality level. Optionally, selecting the minimal quality level required for the requested video stream comprises selecting based at least partially on a quality level received with the request. Optionally, selecting the minimal quality level required for the requested video stream comprises selecting at least partially responsive to an identity of the client. Optionally, selecting the minimal quality level required for the requested video stream comprises selecting at least partially responsive to a rating of the video stream.

Optionally, determining whether the determined available bandwidth can accommodate the requested video stream at the minimal quality level comprises determining based on a list of a plurality of quality levels and respective sizes prepared in advance before receiving the request. Optionally, determining the available bandwidth and determining whether the determined available bandwidth can accommodate the requested video stream at the minimal quality level comprises determining for each of one or more video streams already determined to be provided on the link to the client a minimal size required for supplying the stream at a respective quality level and determining whether the requested video stream and the video streams already determined to be supplied on the link can fit altogether on the link. Optionally, the determination is performed with a same quality level for all the video streams.

There is further provided in accordance with an exemplary embodiment of the invention, a video server, comprising: a plurality of preparation units, each preparation unit being configured to provide data units of a video stream, which can be used to entirely reconstruct the video stream, each preparation unit supplying for at least 10% of the blocks of the video stream data units of different sizes representing the same video content; and one or more channel loaders configured to receive the data units from the plurality of preparation units and to generate therefrom a video stream of a desired size or quality level, using data units from all the plurality of preparation units when they are all operative and using data units from fewer than all the preparation units when one or more of the preparation units is inoperative.

Optionally, each of the plurality of preparation units is adapted to provide data units in a plurality of different quality levels. Optionally, the difference between the plurality of different quality levels of a single preparation unit is at least three times greater than the difference between the different quality levels of two different preparation units, having closest quality levels. Optionally, the plurality of preparation units are included in a single casing.

Optionally, at least one of the plurality of preparation units is configured to provide data unit listings for generation of a plurality of video streams of different sizes using data units from both the preparation units. Optionally, the at least one of the plurality of preparation units is configured to additionally provide data unit listings for generation of a plurality of video streams of different sizes using only the data units of the providing preparation unit.

There is further provided in accordance with an exemplary embodiment of the invention, a method of preprocessing a video stream, comprising receiving a video stream formed of a sequence of blocks, compressing each of at least a plurality of the blocks of the video stream, using a plurality of different parameter sets, selecting a sub-group including at least two of the plurality of parameter sets, based on the corresponding compressed blocks and generating data units for use with the video stream, based on the selected parameter sets.

Optionally, selecting the sub-group of parameter sets comprises selecting responsive to quality levels of the compressed blocks.

### BRIEF DESCRIPTION OF FIGURES

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic block diagram of a two part compression system, in accordance with an exemplary embodiment of the invention;

FIG. 2 is a flowchart of acts performed by a preparation unit, in accordance with an exemplary embodiment of the invention;

FIG. 3 is a schematic illustration of a video stream representation, in accordance with an exemplary embodiment of the invention; and

FIG. 4 is a schematic illustration of a video server, in accordance with an exemplary embodiment of the invention.

### DETAILED DESCRIPTION OF EMBODIMENTS

### Overview

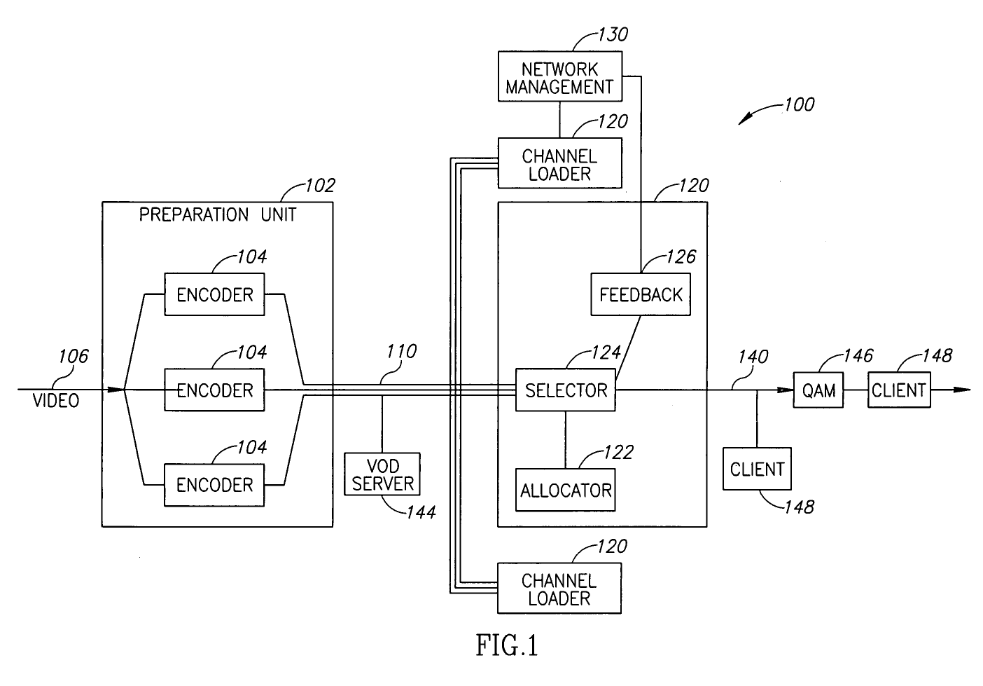

FIG. 1 is a schematic block diagram of a two-part compression system 100, in accordance with an exemplary embodiment of the invention. Compression system 100 comprises a preparation unit 102 including a plurality of encoders 104 adapted to encode a single video stream received on an input line 106 at a plurality of different quality levels. The encoded streams, along with indications of the respective quality levels of the streams, are provided over a communication channel 110 to one or more channel loaders 120. A selector 124 of channel loader 120 selects, for each time interval of the video stream, a single data unit representation of the video stream for transmission over a communication channel 140, to one or more clients 148 directly or through a quadrature amplitude modulation (QAM) tuner 146, or any other mediation unit. A bandwidth allocator 122 optionally notifies selector 124 about the current bandwidth allocated to the video stream for each time interval, and accordingly selector 124 selects data units from one of the quality level encoded streams.

A feedback unit 126 optionally collects statistics regarding the proportion of time in which data units of each of the quality levels is selected, and generates reports accordingly. In some embodiments of the invention, when video streams supplied by system 100 suffer from a low quality level for more than a predetermined percentage of time, a warning message is generated. Optionally, in such cases the bandwidth of communication channel 110 is increased or the number of video streams concurrently transmitted on the channel 110, is decreased. In some embodiments of the invention, a network management unit 130 uses the statistics from feedback unit 126 to route video streams to clients in a manner which maximizes the video image quality, when multiple optional communication channels are available, for example when multiple QAMs 146 can be used to service a specific client 148.

System 100 may be used for real time video streams or for prestored video streams, for example in video on demand (VoD) services. When handling real time video streams, channel loader 120 processes the video stream a short time (for example less than 1 minute or even less than five seconds) after it is handled by preparation unit 102. In non-real-time embodiments, the handling by preparation unit 102 may be performed more than an hour, more than a day or even more than a week before the handling by channel loader 120. In some embodiments of the invention, a video on demand (VoD) server 144 stores video streams generated by preparation unit 102, which are later provided to channel loader 120, on demand.

The blocks of the video stream handled separately may be at least the size of a frame, or even a group of pictures (GOP) or may be smaller than a single frame, possibly being the size of a single macro-block.

Clients 148 may be any suitable device for receiving video, including television sets, computers and cellular phones. Communication channel 140 may include a cable or satellite connection, a packet based (e.g., Internet) connection, a wireless connection or other connections suitable for video delivery. Communication channel 140 may be dedicated solely for video delivery or may be used for various communication tasks.

### Encoders

In some embodiments of the invention, each encoder 104 comprises a plurality of sub-encoders (not shown), which generate different encoded representations of each block of the video stream. The generated representations are evaluated to assign them quality levels and the representation with the quality level of the encoder 104 is provided by the encoder. In some embodiments of the invention, when there is no exact match, the encoded representation having the closest quality level to the target level of encoder 104 is selected. Alternatively, the encoded representation having the closest quality level above the target quality level is selected, such that at least the target quality level, which may have been promised to the client, is provided. Further alternatively, an encoded representation having a quality level above the target quality level and a size smaller than a predetermined value, is selected. Thus, in some embodiments of the invention, blocks which easily compress to high quality levels may be represented by quality levels substantially higher than the target value. In some embodiments of the invention in which the encoded blocks do not depend on previously encoded blocks (e.g., only B-frames are encoded and/or in encoding I-frames) that differ for different encoders 104, the sub-encoders are shared by the encoders 104.

In other embodiments of the invention, encoder 104 performs the encoding of blocks iteratively until the desired quality level is reached. Optionally, a default set of encoding parameters, based on the quality level of the encoder 104, is used by encoder 104 in a first encoding step of each block. The encoded block is evaluated for its quality level and according to whether the quality level is too high or too low the parameters are adjusted and a second encoding is performed. The resulting encoded block is evaluated for quality level and the process is repeated, until the quality level of the encoder is reached. Optionally, a quality level is considered reached if the different between the actual quality level and the target quality level is less than a predetermined gap size, for example 5%, 3% or 1% of the quality level of the maximal quality representation of the block.

In some embodiments of the invention, encoders 104 combine parallel and sequential methods to achieve the desired quality level. For example, a closest encoded block may be selected from a plurality of blocks generated by sub-encoders and then the closest encoded block is iteratively adjusted until the quality level of the encoder 104 is reached.

The encoders 104 and/or sub-encoders may be implemented in hardware, software or combinations thereof. For example, a single unit may perform the tasks of a plurality, or even all, of encoders 104, sequentially or partially or entirely in parallel. Encoders 104 may be implemented, for example, as described in above mentioned, U.S. Pat. No. 7,082,167.

### Exemplary Encoding Method

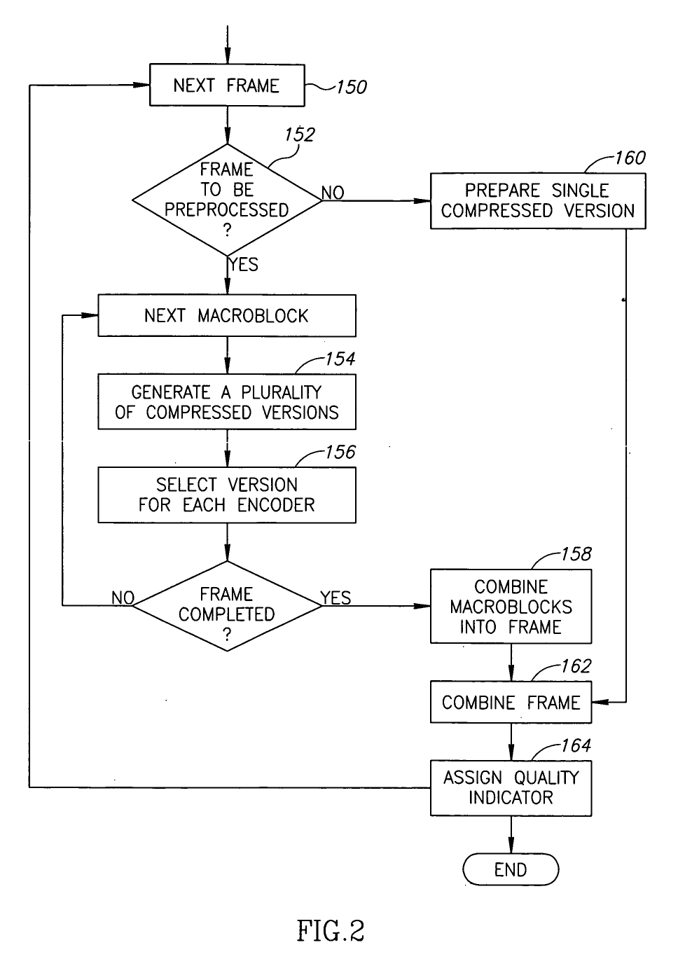

FIG. 2 is a flowchart of acts performed by preparation unit 102, in accordance with an exemplary embodiment of the invention. For each frame (150) of the video stream, preparation unit 102 determines (152) whether to prepare a plurality of quality levels for the frame. Frames for which a plurality of quality level data units are to be prepared, are optionally processed macroblock after macroblock. For each macroblock of the frame, preparation unit 102 optionally generates (154) a plurality of compressed versions using different compression parameters and selects (156) for each encoder 104 one of the compressed versions of the macroblock, best fulfilling a quality constraint of encoder 104. Each respective encoder 104 combines (158) its selected macroblocks to form a compressed version of the frame.

A single compressed version is prepared (160) for frames not requiring a plurality of quality levels, and this version is provided to all of encoders 104. The single compressed version may be generated using any method known in the art, including generation of a plurality of compressed versions using different compression parameters and selecting one of the compressed versions which meets quality constraints required for the single compressed version. Optionally, the generated frames are combined (162) in each encoder 104 to form groups of pictures (GOPs) meeting the quality constraints of the respective encoder 104. In some embodiments of the invention, each frame or GOP is assigned (164) an indication of its quality level or an indication of the constraints it meets. The quality indication is optionally transmitted to channel loader 120 with its respective video stream.

Referring in detail to generating (154) the compressed versions, in some embodiments of the invention, the compressed versions differ in the quantization used by the encoder, for example using different quantization scale levels for different compressed versions. Alternatively or additionally, the compressed versions differ in the resolution and/or frame rate of the images of the video stream. Further alternatively or additionally, values of other parameters, such as the motion vectors used and/or macro-block types, are adjusted in generating the different compressed versions. In some embodiments of the invention, the encoding is performed in such a manner that higher quality compressed versions are always larger than lower quality compressed versions of the same image block.

In some embodiments of the invention, in which the compressed versions differ in their quantization scale levels, compressed versions are generated for all quantization scale levels. Optionally, if the received video stream is already compressed, compressed versions are generated only for quantization scale levels above the quantization scale level of the received video stream. For example, in a compression scale having 32 quantization scales, if the received video stream was encoded with quantization scale number 9, compressed versions are generated for all of the quantization scales from 10-32. Alternatively, in order to reduce processing power requirements, compressed versions are generated for every second quantization scale or for every third or fourth quantization scale in the range of quantization scales above the quantization scale of the received stream. Further alternatively, compressed versions are generated only for a limited number of quantization scales, for example three quantization scales. In some embodiments of the invention, the quantization scales used are selected based on tests on a plurality of video streams, as quantization scales that provide a best ratio between compression extent and quality level. Alternatively, as mentioned above, the quantization scale used may be selected in an iterative process. Optionally, in accordance with this alternative, a plurality of quantization scales with gaps between them, are used, and further quantization scales between the blocks with the closest quality level are generated.

Optionally, the number of quantization scales for which compressed versions are generated is greater than the number of encoders 104, by at least 2, or even at least 5, in order to allow for a wide selection from the compressed versions. Alternatively, in order to reduce processing power consumption, the number of quantization scales for which compressed versions are generated is only one greater than the number of encoders 104.

Alternatively, as mentioned above, other methods may be used to select a proper quality compressed version, for example iterative compression and adjustment based on quality level.

The resultant compressed GOPs or other blocks of the encoders 104 optionally have variable sizes over the video stream, according to the size required to meet the quality level constraints.

In some embodiments of the invention, the compressed versions are generated using the same compression methods, regardless of the source of the video stream and/or its content. In other embodiments of the invention, the method of generating the compressed versions, for example, the number of quantization scales for which compressed versions are generated and/or the specific quantization scales used, depends on the source and/or content of the video stream. In some embodiments of the invention, the method of generating the compressed versions depends on the type of the content of the video stream (e.g., sports, talk show, action, concert), for example as determined from an electronic program guide (EPG) entry for the video stream. Alternatively or additionally, the method of generating the compressed versions depends on an importance rating of the video stream. The importance may depend, for example, on the number, payment and/or importance of the clients receiving the video stream and/or on the importance or payment of the provider of the video stream. In an exemplary embodiment of the invention, the importance is a function of a rating measure, such as the Nielsen rating measure.

Optionally, encoders 104 manage statistics regarding how successful previous method selections were (e.g., based on their compression to quality degradation ratio), as a function of various attributes of the video streams and accordingly select the method to be used for a specific video stream. The attributes may include, for example, the source of the video, its content type and/or a user rating of the video stream. For real-time channels, the attributes optionally also include the time of day and/or the channel on which the video is transmitted. In some embodiments of the invention, the type of the video is determined by an image analysis of several frames of the video stream. Alternatively, the type of the video is determined from external information accompanying the video, such as from an EPG of the video stream.

### Quality Level Measurement

The quality level is optionally measured from an evaluation of the image after it is encoded and not directly from the parameter values used in generating the image. In some embodiments of the invention, the quality level is measured relative to the quality of the received video stream. Alternatively, the quality level is measured partially or entirely based on objective attributes of the image, for example whether it includes known artifacts, and not in relation to any other image.

The quality level of frames or portions thereof (e.g., macro-blocks) is optionally measured using any suitable method known in the art, such as based on peak signal noise ratio (PSNR) or any of the methods described in “Survey of Objective Video Quality Measurements”, by Yubing Wang, downloaded from ftp://ftp.cs.wpi.edu/pub/techreports/pdf/06-02.pdf, the disclosure of which is incorporated herein by reference.

In some embodiment of the invention, the quality level is measured using any of the methods described in U.S. Pat. No. 6,577,764 to Myler et al., issued Jun. 10, 2003, U.S. Pat. No. 6,829,005 to Ferguson, issued Dec. 7, 2004, and/or U.S. Pat. No. 6,943,827 to Kawada et al., issued Sep. 13, 2005, the disclosures of which are incorporated herein by reference. Alternatively or additionally, the quality level is measured using any of the methods described in “Image Quality Assessment: From Error Measurement to Structural Similarity”, Zhou Wang, IEEE transactions on Image Processing, vol. 13, no. 4, April 2004, pages 600-612 and/or “Video Quality Measurement Techniques”, Stephen Wolf and Margaret Pinson, NTIA Report 02-392, June 2002, the disclosures of both of which are incorporated herein by reference. It is noted that the quality level function may be in accordance with a single one of the above cited references or may combine, for example in a linear combination, features from a plurality of the above articles and patents.

### Quality Levels

The determination (152) of whether to prepare a plurality of quality levels for the frame optionally depends on the type (e.g., B, P or I) of the frame. In an exemplary embodiment of the invention, B type frames are encoded at both 80% and 90% quality levels, while P and I frames are encoded only at a 90% quality level. Alternatively, a plurality of quality level versions are generated for all blocks.

The quality levels of encoders 104 are optionally chosen to provide a sufficiently high quality level which can fit on communication channel 140 on the one hand and to provide sufficiently small encoded blocks which will fit on channel 140 when bandwidth is scarce, on the other hand. In an exemplary embodiment of the invention, encoders for quality levels of 90%, 80% and 70% are used, where the quality levels relate to the quality of the compressed block relative to the block in its uncompressed form. In another exemplary embodiment of the invention, only two quality levels are used. Optionally, a first quality level is selected at a level at which even an expert cannot see substantial differences between the source and the compressed video, for example 96%. A second quality level is optionally at a level at which most people do not identify differences, for example 90%.

The quality levels provided by encoders 104 are optionally configurable by a system manager, according to the needs of the network. Alternatively or additionally, the quality levels provided by encoders 104 are selected automatically for each video stream, according to parameters of the video stream, such as resolution, momentary bit rate, accumulated bit rate of multiple channels multiplexed together by channel loader 120 and/or complexity. In some embodiments of the invention, the quality levels are selected responsive to the source and/or content of the video stream, for example based on the type of the video stream as determined from an EPG entry and/or based on a quality of service (QoS) rating of the video stream. Alternatively or additionally, any of the options described above regarding selection of the compression methods may be used in selecting the quality levels.

In some embodiments of the invention, the quality levels generated for a video stream are selected responsive to one or more attributes of the stream. Optionally, preparation unit 102 manages a table which lists for each set of one or more attributes, the quality levels to be generated for the streams having the one or more attributes. In some embodiments of the invention, it is desired to generate blocks having predetermined sizes which are best suited for transmission to clients. Optionally, the quality levels for each set of one or more attributes are selected as those which are expected to achieve blocks having sizes close to the predetermined sizes. In some embodiments of the invention, preparation unit 102 updates the quality levels in the table on a continuous basis, based on the results of compression previous blocks. Optionally, if the resultant size is persistently smaller or greater than the intended size, the quality levels are adjusted so that subsequent compressed blocks result in the desired size.

In real time embodiments, when the compression results for a block have a size different from that desired, preparation unit 102 may not have sufficient time to redo the compression and the resultant blocks are used although their size is not the desired size. In non-real-time embodiments of the invention, however, when the compressed blocks are not of the desired size, the compression is preferably repeated to achieve the desired size. Using the attributes of the stream to select the initial quality levels optionally reduces the percentage of blocks for which such repetition is required.

In some embodiments of the invention, the quality levels provided by encoders 104 are adjusted during preparation of a single stream, based on feedback from channel loader 120 or from a plurality of channel loaders 120.

Optionally, the quality levels provided by encoders 104 are adjusted responsive to the quality of the image. For example, when the received image has a relatively low quality, quality levels which reduce the quality only a little may be used. Alternatively or additionally, when an image is complex, quality levels which substantially reduce the size of the image may be prepared. In some embodiments of the invention, however, when the image is complex, data units which represent quality levels which only slightly reduce the quality are provided, in order not to lose details in the complex image.

### Stream Construction

In some embodiments of the invention, in addition to providing the data units representing the blocks of the video stream, preparation unit 102 determines data unit selections for a plurality of different stream sizes and provides data unit listings for each of a plurality of different stream sizes. Channel loaders 120 receiving the data units, select the data units to be transmitted to clients based on the listing for the current size of the channel leading to the client. In some embodiments of the invention, preparation unit 102 determines the quality levels of the streams of the data unit listings and provides an indication of the quality level with each data unit listing. Alternatively, one or more of the streams are generated responsive to a desired quality level rather than a size.

In some embodiments of the invention, the data unit listings represent constant bit rate (CBR) streams. Optionally, data unit listings are generated for predetermined stream sizes. In an exemplary embodiment of the invention, data unit listings are generated for channel sizes of 3.75 Mbps, 3.2 Mbps, 2.8 Mbps and 2.5 Mbps. Listings may be generated for more, fewer and/or different sizes. The channel loader simply selects a listing according to the available size and accordingly selects and/or generates the data units loaded onto the channel. In other embodiments of the invention, data unit listings are generated for specific quality levels, not necessarily at a specific fixed size but also possibly variable bit rate (VBR) streams or pseudo VBR streams. A channel loader or statistical multiplexer may use the listings to easily generate equal quality streams of a size close to a specific fixed or average desired size. Optionally, in generating the listings, preparation unit 102 distributes lower quality blocks evenly in the stream, so that their effect is less noticeable. Alternatively or additionally, the lower quality blocks used are selected as those that in their compression achieve a largest size gain, a lowest quality degradation and/or a smallest size gain to quality loss ratio.

### Communication Link

In some embodiments of the invention, communication channel 110 connecting channel loader 120 to preparation unit 102 is an internal connection within a single casing including both preparation unit 102 and channel loader 120, such as described in U.S. Pat. No. 5,847,760. Alternatively, communication channel 110 comprises a relatively long distance connection of at least 100 meters or even more than 10 kilometers. In some embodiments of the invention, communication channel 110 operates in accordance with a standard communication protocol, such as IP, Ethernet and/or another packet based protocol. In some embodiments of the invention, communication channel 110 comprises a local area network (LAN) or a wide area network (WAN). Optionally, one or more portions of communication channel 110 pass over a wireless link, for example a satellite or cellular communication link.

Optionally, preparation unit 102 generates video streams with respective quality level indications for a plurality of channel loaders 120. In some embodiments of the invention, the plurality of channel loaders are located in separate locations distanced from each other by at least 10 or even at least 100 meters.

In some embodiments of the invention, all the data unit representations of a single block are provided together on a single communication channel. Alternatively, different representations are provided on different communication channels. The different channels may pass over different physical links or may pass over the same physical link, but have different quality parameters, such as different redundancy (e.g., forward error correction FEC) protection.

Furthermore, in some embodiments of the invention, the video stream at its highest quality is provided from a first site, while data units corresponding to other quality levels are provided from a second, different, site. The different sites may be managed by different entities and/or may be managed by different servers located on different computers, optionally in different rooms. In some embodiments of the invention, the first and second sites are in different locations separated by at least 100 meters or even at least 10 kilometers. Supplying the data units corresponding to other quality levels from a different site, allows using a proprietary system for distribution of the video stream, without adaptations, as the additional data units of other quality levels are provided separately.

### Channel Loader

In some embodiments of the invention, channel loader 120 selects for each video stream a default quality level to be used for the stream throughout its transmission, unless sufficient bandwidth is not available momentarily. Alternatively, channel loader 120 periodically, for example every 100 milliseconds or every minute, selects a quality level to which the video stream is to be compressed, in an attempt that the selected quality level will maximize the utilization of the channel. Optionally, the quality level is selected responsive to the size of the channel onto which the video stream is loaded and one or more attributes of the video stream. The one or more attributes may include, for example, external information, such as from an EPG. Alternatively or additionally, the one or more attributes include a size of current blocks of the video stream and/or previous successes of the selected quality. In some embodiments of the invention, when the compressed video portion based on the selected quality is larger than the channel or is substantially smaller than the channel, channel loader 120 repeats the compression to achieve more accurate results. Alternatively, the compression is corrected in subsequent portions of the video stream.

Optionally, in non-real-time embodiments, preparation unit 102 provides, along with the video stream, statistics on the average size of the video stream for the different quality levels and accordingly channel loader 120 selects the default quality level. Optionally, channel loader 120 does not provide video data at a quality level above the default even when the bandwidth is available. Using a default quality level may allow simpler operation of channel loader 120, without substantially affecting the quality perceived by the human client, as humans generally do not appreciate short durations of higher video quality.

Alternatively to using a default quality level, channel loader 120 uses the largest quality level block that fits on the allocated bandwidth. In some embodiments of the invention, each block is marked with its size together with its quality level for simple operation.

In some embodiments of the invention, channel loader 120 is part of a statistical multiplexer, which combines a plurality of video streams of different content onto channel 140. Optionally, the quality level indications of the blocks of the different video streams being combined onto the communication channel, and the respective sizes of the blocks are used by bandwidth allocator 122 in assigning bandwidth to each of the video streams. In some embodiments of the invention, channel loader 120 provides variable bit rate (VBR) streams in order to maximize the utilization of the channel. Alternatively, for delivery convenience, channel loader 120 provides constant bit rate (CBR) video streams having sizes selected according to the needs of the streams currently statistically multiplexed. Further alternatively or additionally, channel loader 120 provides pseudo VBR video streams, which have a fixed size for short intervals. The fixed size is selected for each interval, which intervals are optionally shorter than 10 seconds, shorter than 5 seconds or even shorter than 2 seconds.

Optionally, the bandwidth allocation is performed in a manner which achieves a substantially equal quality level for all the video streams, for example with variations smaller than 1% or even less than 0.5%. Alternatively, the bandwidth allocation is performed in a manner which evenly distributes the reduction in quality between the video streams, when different streams are received originally by preparation unit 120 at different quality levels. Further alternatively or additionally, the bandwidth allocation is performed according to respective quality of service (QoS) ratings of the video streams. In some embodiments of the invention, the bandwidth allocation is performed in a manner which maximizes the combined quality levels of all the streams. Further alternatively or additionally, the bandwidth allocation is performed in a manner which achieves a predetermined relative quality difference between the various streams multiplexed together. For example, it may be determined that a first group of video streams should have a quality level two percentage points higher than the quality level of a second group of streams and the quality levels are selected accordingly.

In some embodiments of the invention, the relative quality levels depend on one or more attributes of the clients receiving the streams. Optionally, the relative quality levels depend on the quality of service ratings of the clients receiving the streams, according to their service agreements (e.g., subscribers verses non-subscribers) and/or based on whether the clients agree to receive advertisements. In some embodiments of the invention, the relative quality levels depend on the numbers of clients currently receiving the streams and/or the numbers of clients estimated statistically to be viewing the streams. Alternatively or additionally, the relative quality levels depend on one or more attributes of the video streams, such as the importance of the video (e.g., newer movies are considered more important and therefore are provided with higher quality levels). Further alternatively or additionally, the relative quality levels depend on the providers of the video streams, for example according to delivery payments. Optionally, channel loader 120 needs to load a plurality of video channels onto a communication channel of a given bandwidth, such as 38.8 Mbps. Channel loader 120 optionally determines the relative quality levels of the video channels and then determines for various absolute quality levels whether the streams will fit onto the communication channel. The quality level selected is optionally the level which achieves the highest quality that still fits on the channel. Optionally, the size determination is performed based on information received from preparation unit 102.

In other embodiments of the invention, channel loader 120 is used to fit a single video stream onto a channel, either a fixed size channel or an average sized channel, for example a packet based allocated channel of an average size. Channel loader 120 may use buffering in order to fit the single video stream into a constant or pseudo VBR channel.

### Routing Decisions

In some embodiments of the invention, channel loader 120 or some other unit which responds to user request's from the channel loader, determines whether to comply to a request for a video stream at least partially based on a determination of whether the video stream can be provided at a given quality level. Alternatively or additionally, a route for delivery of the video stream is selected responsive to the quality levels that can be guaranteed (and/or the level of assurance that a quality level will be provided) by the different routes. Channel loader 120 optionally estimates the quality level that it will provide if the newly requested video stream will be provided with the streams currently provided and accordingly determines whether to provide the newly requested video stream. In some embodiments of the invention, the request is provided with an indication of the minimal desired quality. Alternatively, a network manager defines the minimal allowed quality level. In some embodiments of the invention, the minimal allowed quality level is a function of one or more attributes of the specific video stream and/or the specific client receiving the stream.

In some embodiments of the invention, by preparation unit 102 associates each video stream with a simple size measure which provides channel loaders 120 and/or network management unit 130 with an indication of the bit rate required for the video stream. The simple size measure is optionally based on a maximal data unit size of the video stream at a low quality level (e.g., 90%), referred to herein as X1. Alternatively or additionally, the simple size measure is based on the average data unit size of the video stream at a high quality level (e.g., 96%), referred to herein as X2. In an exemplary embodiment of the invention, the simple size measure is the maximum of X1 and X2. This simple size measure is optionally used in determining whether to accept a request for transmission of an additional video stream on a give size channel. Alternatively or additionally, the simple size measure is a weighted average of an average size of the low quality level and the average size of the high quality level, with the weight of the low quality level being equal to the percentage for which the low quality level is tolerated. The simple size measure may be used, for example, in guaranteeing bandwidth in a packet based (e.g., IP) network, such that the video stream will be delivered over the network at the required quality of service. Other measures that may be used include the average of X1 and X2 or the minimum of X1 and X2, for example when lower quality delivery is allowed.

For non-real time video streams, the simple size measure is optionally determined in advance, based on the contents of the entire video stream. For real time streams, on the other hand, the simple size measure is optionally determined on the fly, based on the portion of the video stream already viewed.

### Delivery to Client

In some embodiments of the invention in which an intermediary unit, such as QAM tuner 146, is utilized on the delivery path to the clients 148, the video stream transmitted from channel loader 120 to QAM tuner 146, is padded with null packets so that it has a constant size. This makes the operation of QAM tuner 146 simpler, as it does not need to deal with timing issues due to receiving video streams of different sizes. In an exemplary embodiment of the invention, the streams transmitted by channel loader 120 are padded from a content CBR size (e.g., 2.4, 2.8 or 3.2 Mbps) or from a pseudo VBR content to a maximal CBR size, such as 3.75 Mbps.

### Alternatives

Instead of providing for each block of the video stream a complete representation of the block for each quality level, in some embodiments of the invention, one or more of the data units representing a block for a specific quality level comprise compression hints. Compression hints may allow fast, inexpensive and/or accurate generation of the quality level data unit representation from the highest level data unit provided, thus reducing the bandwidth required for transmission to channel loader 120 and/or the storage space required on VoD server 144. The compression hints optionally include the values of the parameters used in the compression, such as the quantization and/or motion vectors used. Alternatively or additionally, the compression hints include a down sampling method and/or extent to be used. In an exemplary embodiment of the invention, complete data units are provided for between two to four major quality levels and compression hints are provided for additional quality levels. In other embodiments of the invention, a complete data unit is provided for only a single quality level and one or more additional quality levels are represented only by hints.

In some embodiments of the invention, instead of providing data units of a plurality of quality levels for all the blocks of the video stream, a plurality of data units of different quality levels are provided only for some of the blocks of the video stream. For example, data units for a plurality of quality levels, either complete blocks or compression hints, may be provided for specific types of frames, such as only I frames or only B frames. Alternatively or additionally, blocks for which a plurality of data units are provided are selected according to their suitability for compression, for example according to content. Any of the methods known in the art for determining the suitability of blocks for compression may be used, such as those described in U.S. Pat. No. 6,937,619 to Strasman et al., issued Aug. 30, 2005, and U.S. Pat. No. 7,058,087 to Oz et al., issued Jun. 6, 2006, the disclosures of which are incorporated herein by reference.

In some embodiments of the invention, data units of different quality levels are provided for at least 5% or even at least 20% of the blocks of the video stream.

In some embodiments of the invention, each of the data units representing a single block has a unique quality level, different from the quality levels of the other data units representing the block. In other embodiments of the invention, two or more data units represent the same block at the same quality level, but based on different representations of previous blocks of the stream. One or more blocks whose encoding depends on other blocks (e.g., B frames or P frames) are optionally encoded into separate compressed versions for the different encodings of the other blocks on which the encoding of the current block depends.

For example, if a current encoded frame depends on a previous frame which was encoded for both 90% and 80% quality levels, the current frame for 80% quality level may be encoded into two compressed versions of identical image data. A first compressed version relates to the 90% quality level version of the previous frame and the second compressed version relates to the 80% quality level version of the previous frame. A 90% quality level frame may be generated based on the 90% quality level of the previous frame or may be generated for both a previous 80% quality level block and a 90% quality level block. At channel loader 120, the compressed version to be transmitted to the client is selected according to the quality level of the previous block.

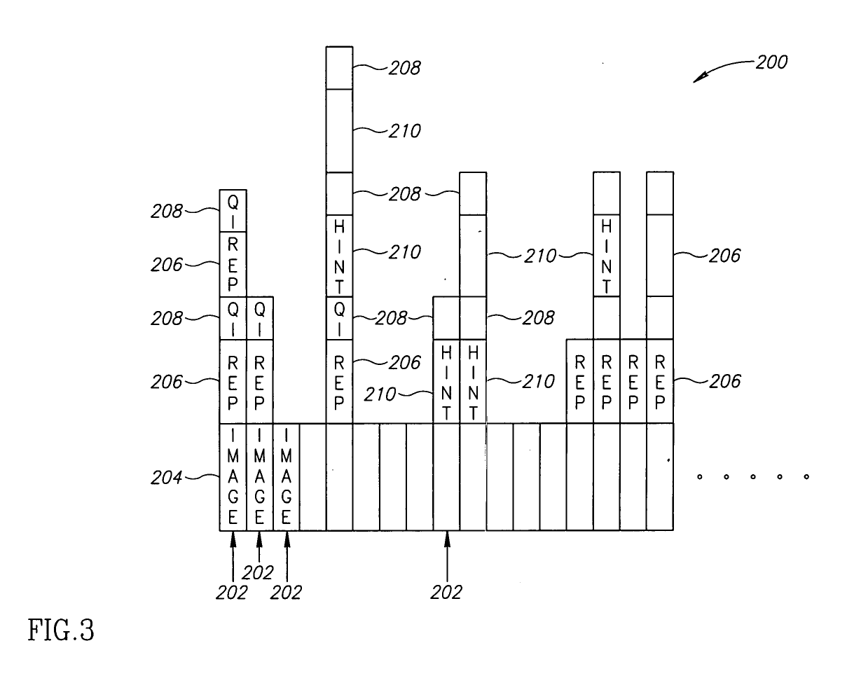

FIG. 3 is a schematic illustration of a video stream representation 200 provided to channel loader 120, in accordance with an exemplary embodiment of the invention. Video stream representation 200 comprises a sequence of image units 202. Each image unit comprises an image block 204 at a maximal quality level provided for the video stream. In addition, at least some of the image units 202 include replacement blocks 206 with respective quality indications 208. In some embodiments of the invention, some of image units 202 include one or more hint blocks 210 with respective quality indications 208, which include parameter values to be used in generating a representation of the image unit 202 from the respective image block 204. The embodiment of FIG. 3 illustrates that not all image units 202 necessarily have representations for quality levels other than used for image block 204 and that not all image units 202 have the same number of quality levels. In some embodiments of the invention, quality indications are also supplied for image blocks 204.

In some embodiments of the invention, as shown in FIG. 3, video stream representation 200 is provided as a variable bit rate (VBR) stream. Alternatively, replacement blocks 206, quality indications 208 and hint blocks 210 are provided as fillers converting a VBR stream formed of image blocks 204 into a CBR stream, for example using any of the methods described in U.S. provisional patent application 60/954,876 to Gutman et al., filed Aug. 9, 2007, the disclosure of which is incorporated herein by reference.

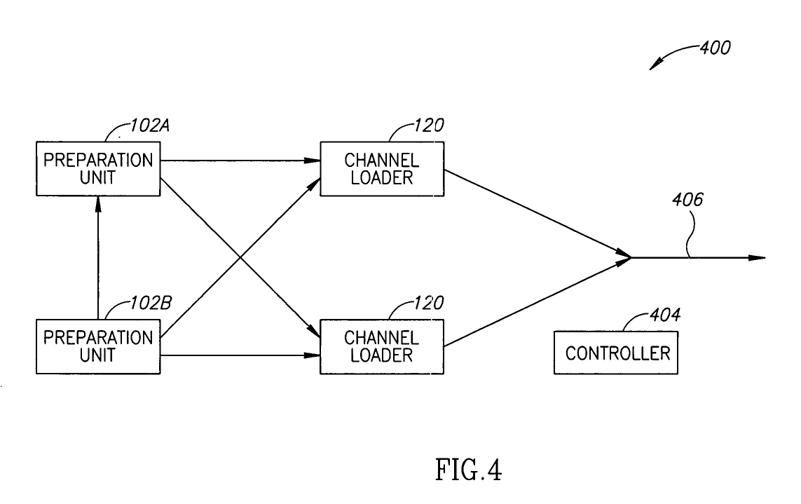

FIG. 4 is a schematic illustration of a video server 400, in accordance with an exemplary embodiment of the invention. For redundancy purposes, supplying back up in case one of the units fails, video server 400 comprises a plurality of preparation units 102 (marked 102A and 102B) and a plurality of channel loaders 120. Preparation units 102 and channel loaders 120 optionally operate continuously, generating video streams for transmission to clients. A controller 404 optionally connects one of the channel loaders 120 to an output channel 406, while the output of the remaining channel loaders is discarded. If a fault in the operation of the channel loader currently connected to output channel 406 is detected, controller 404 immediately connects the output of a different channel loader 120 to output channel 406.

In some embodiments of the invention, preparation units 102A and 102B provide different data units representing the video stream. Optionally, preparation unit 102A provides data units at one or more first quality levels and preparation unit 102B provides data units at one or more second quality levels. In some embodiments of the invention, each of the preparation units 102 provides data units at two quality levels. By providing different quality levels by the different preparation units 102, the number of different quality levels that may be used by channel loaders 120 is enlarged, without a need for extra hardware, as the additional preparation unit 102 is required for redundancy.

The difference between the high and low quality levels of each preparation unit 102 is optionally substantially greater than the difference between the high quality levels of two different preparation units 102. Optionally, the quality levels of a main preparation unit 102A are at a level considered optimal and the quality levels of a backup processing unit are selected at close levels, such that if the main preparation unit 102A is inoperative, the provided data units will be at quality levels close to that considered optimal. In an exemplary embodiment of the invention, preparation unit 102A provides data units at quality levels 96% and 90% and preparation unit 102B provides data units at quality levels 95% and 89%. Alternatively, the quality levels of preparation unit 102B are selected according to the extent of additional options provided when both preparation units 102A and 102B are operative, even if in consequence when the main preparation unit 102A is inoperative, the quality of the transmissions is lower.

In some embodiments of the invention, data unit listings of suggested arrangements of data units of a specific quality and/or size are provided by each preparation unit 102 separately for the data units it generates. Alternatively, one or more of the preparation units 102 provides listings of suggested arrangements of the data units generated by two or more preparation units 102. The preparation unit 102 providing the listings optionally receives the data units generated by the other preparation units and/or their attributes (e.g., size, quality level) from the preparation units 102 generating them, in order to generate the data unit listings. Optionally, different sets of data unit listings are generated for different sets of data units, such that data unit listings are available both for cases in which all of preparation units 102 are operative and for cases in which one or more of the preparation units 102 are inoperative.

### Conclusion

It will be appreciated that the above described methods may be varied in many ways, such as changing the order of steps, and/or performing a plurality of steps concurrently. It will also be appreciated that the above described description of methods and apparatus are to be interpreted as including apparatus for carrying out the methods and methods of using the apparatus. The present invention has been described using non-limiting detailed descriptions of embodiments thereof that are provided by way of example and are not intended to limit the scope of the invention. Many specific implementation details may be used.

It should be understood that features and/or steps described with respect to one embodiment may sometimes be used with other embodiments and that not all embodiments of the invention have all of the features and/or steps shown in a particular figure or described with respect to one of the specific embodiments.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Variations of embodiments described will occur to persons of the art. Therefore, the scope of the invention is limited only by the elements and limitations as used in the claims, wherein the terms “comprise,” “include,” “have” and their conjugates, shall mean, when used in the claims, “including but not necessarily limited to.”

1. A method of preprocessing a video stream, comprising:
receiving a video stream formed of a sequence of blocks;
setting one or more quality level constraints for the video stream;
selecting for each of at least a plurality of the blocks of the video stream, one or more sets of compression parameters for compressing the block, such that the block compressed according to the set of parameters meets a respective quality level constraint set for the video stream; and
generating for each of the sets of compression parameters a corresponding data unit representing the block compressed by the set of compression parameters.

2. A method according to claim 1, wherein setting one or more quality level constraints comprises setting a required minimal quality level.

3. A method according to claim 1, wherein setting one or more quality level constraints comprises setting a required average quality level.

4. A method according to claim 1, wherein setting one or more quality level constraints comprises setting constraints which do not change over the entire video stream.

5. A method according to claim 1, wherein setting one or more quality level constraints comprises setting constraints which vary over the video stream.

6. A method according to claim 1, wherein selecting one or more sets of compression parameters comprises compressing the block according to a plurality of different sets of parameters and selecting a sub set of compression parameters that meet the quality level constraints.

7. A method according to claim 6, wherein the quality constraints comprise average quality values and selecting the sub set of compression parameters comprises selecting the compression parameters resulting in compressed blocks having a quality level closest to respective average quality values.

8. A method according to claim 6, wherein compressing the block according to a plurality of different sets of parameters comprises compressing according to at least some parameters selected responsive to external information on the general content of the video stream.

9. A method according to claim 8, wherein the external information is retrieved from an external program guide describing the stream.

10. A method according to claim 1, wherein selecting one or more sets of compression parameters comprises iteratively adjusting the parameters based on test compressions.

11. A method according to claim 1, wherein generating the corresponding data unit comprises compressing the block according to the set of compression parameters, such that the data unit is a compressed version of the block meeting the quality level constraint.

12. A method according to claim 1, wherein generating the corresponding data unit comprises generating a data unit including the set of compression parameters, but not the video block.

13. A method according to claim 1, wherein the block comprises a group of pictures (GOP).

14. A method according to claim 1, comprising calculating one or more values indicative of a bit rate of the stream corresponding to each of the one or more quality level constraints, responsive to the selection of the compression parameters.

15. A method according to claim 1, wherein setting the one or more quality level constraints comprises setting responsive to a rating of the video stream.

16. A method according to claim 1, wherein setting the one or more quality level constraints comprises setting responsive to a request of a provider of the video stream.

17. A method according to claim 1, comprising providing quality indications with at least some of the data units.

18. A method according to claim 1, wherein for at least a plurality of the blocks, a plurality of data units of different quality levels are generated.

19. A method according to claim 18, wherein a plurality of data units of different quality levels are provided for at least 5% of the blocks of the video stream.

20. A method according to claim 18, wherein a plurality of data units of different quality levels are provided for at least 50% of the blocks of the video stream.

21. A method according to claim 18, wherein providing one or more data units for each of the blocks of the video stream comprises providing the video stream from a first location and additional units from a second location.

22. A method according to claim 18, comprising selecting for each time interval corresponding to a block of the video stream, a single data unit representing the video stream in the time interval.

23. A method according to claim 22, wherein selecting for each time interval a single block is performed at least an hour after selecting the compression parameters.

24. A method according to claim 22, comprising taking note of the quality levels of the selected blocks.

25. A method according to claim 22, wherein selecting for each time interval a single data unit is performed at a location distanced from the location in which the compression parameters are selected.

26. A method according to claim 18, comprising generating for at least one set of compression parameters for a specific current block of the video stream a plurality of data units representing the current block at a same quality level but differing in a quality level of a previous block on which the encoding of the current block depends.

27. A method according to claim 1, comprising verifying that the set of compression parameters achieve the quality level constraint by compressing the blocks using the set of compression parameters and comparing the compressed block to the original block to determine the quality level.

28. A video preparation unit, comprising:
an input interface for receiving video streams formed of sequences of blocks;
an output interface for providing preprocessed data units for the video stream; and
one or more encoders configured to select for at least 5% of the blocks of video streams received through the input interface, compression parameters suitable for compressing the block into a compressed block meeting a quality level constraint associated with the video stream, and to forward data units including the compression parameters or compressed versions of the blocks generated according to the compression parameters, through the output interface.

29. A preparation unit according to claim 28, wherein the one or more encoders are configured to forward the data units with the video stream.

30. A preparation unit according to claim 28, wherein the one or more encoders are configured to forward the data units without the video stream.

31. A preparation unit according to claim 28, wherein the one or more encoders are configured to forward the compression parameters or the data units along with quality indications.

32. A preparation unit according to claim 28, wherein the one or more encoders are adapted to calculate one or more values indicative of a bit rate of the stream corresponding to the quality level constraint associated with the video stream.

33. A method of channel loading one or more video streams, comprising:
receiving one or more video streams, including sequences of data units representing blocks of the video stream, wherein at least 1% of the blocks of the video stream are represented by a plurality of data units having different quality levels;
determining quality levels of the data units;
selecting for each of the one or more video streams, at each time point, a single data unit to represent the video stream at the time point, responsive to the determined quality levels; and
loading representations of the one or more video streams onto a communication channel, responsive to the selected data units.

34. A method according to claim 33, wherein loading representations of the one or more video streams onto a communication channel comprises loading each of the one or more streams as a constant bit rate stream on its own.

35. A method according to claim 33, wherein loading representations of the one or more video streams onto a communication channel comprises loading the one or more streams together as a constant bit rate stream.

36. A method according to claim 33, wherein each of the data units comprises a compressed version of the block or a respective set of compression parameters to be used in compressing the block.

37. A method according to claim 33, wherein receiving one or more video streams comprises receiving a plurality of video streams by a statistical multiplexer.

38. A method according to claim 37, wherein selecting for each video stream a single data unit comprises selecting in a manner which evenly distributes reduction in quality between the video streams.

39. A method according to claim 37, wherein selecting for each video stream a single data unit comprises selecting in a manner which causes the video streams to have substantially even quality levels.

40. A method according to claim 37, wherein selecting for each video stream a single data unit comprises selecting in a manner which maximizes the overall quality level of all the video streams.

41. A method according to claim 33, wherein determining the quality levels of the data units comprises receiving level indications with the data units.

42. A method according to claim 33, wherein determining the quality levels of the data units comprises determining the quality levels by a same processor performing the selecting.

43. A channel loader, comprising:
an input interface for receiving video streams formed of sequences of blocks;
an output interface for loading video streams onto a communication channel; and
a processor configured to receive through the input interface sequences of data units of one or more video streams, to determine quality levels of the data units, to select for each of the one or more video streams, at each time point, a single data unit to represent the video stream at the time point, responsive to the determined quality levels and to load representations of the one or more video streams onto a communication channel through the output interface, responsive to the selected data units.

44. A method of channel loading, comprising:
determining one or more video streams to be provided on a delivery channel;
receiving an indication of a bit rate of the delivery channel; and
selecting for each of the one or more video streams a target quality level to which the video stream is to be compressed, responsive to the bit rate of the delivery channel.

45. A method according to claim 44, wherein selecting the target quality comprises selecting responsive to the compression sizes achieved for previous blocks of the video stream.

46. A method according to claim 44, wherein selecting the target quality comprises selecting responsive to the compression sizes achieved for similar blocks of the video stream or of similar video streams.

47. A method according to claim 46, wherein the similar video streams have a similar entry in an electronic program guide as the current video.

48. A method according to claim 44, comprising compressing the one or more video streams to the selected quality levels.

49. A method according to claim 48, comprising repeating the compression of one or more blocks of a stream if the bit rate of the compressed block is substantially different from the bit rate of the delivery channel.

50. A method according to claim 44, wherein the one or more video streams comprise a plurality of video streams.

51. A method according to claim 50, comprising receiving rules defining the relative quality levels of the streams to be provided on the delivery channel.

52. A method according to claim 51, wherein providing the rules defining the quality levels of the streams comprises providing a rule requiring that the streams have substantially equal quality.

53. A method according to claim 51, wherein providing the rules defining the quality levels of the streams comprises providing a rule defining a plurality of groups of streams, the streams of each group having substantially the same quality level, which is different from the quality levels of the other groups.

54. A method according to claim 51, wherein providing the rules defining the quality levels of the streams comprises providing a rule requiring a predetermined difference between the quality levels of at least two streams.

55. A method according to claim 50, wherein encoding the streams comprises encoding each stream into a constant bit rate stream.

56. A method according to claim 50, wherein the encoding is performed by a channel loader which receives indications of a plurality of quality levels and respective sizes for at least two of the video streams, along with the video streams.

57. A method according to claim 50, wherein the encoding is performed by a channel loader which receives indications of a plurality of quality levels and respective sizes for at least two of the video streams, from a separate entity.

58. A method according to claim 44, wherein determining video streams to be provided on the channel comprises determining whether to accept an additional request for a video stream, responsive to an expected quality level at which the video stream will be supplied.

59. A method according to claim 44, wherein compressing the one or more video streams comprises encoding in a manner which maximizes the quality levels of the one or more streams, while the streams still fit on the delivery channel.
